(19) United States
(12) Patent Application Publication
(10) Pub. No.: US 2007/0090947 A1
(43) Pub. Date: Apr. 26, 2007

(54) Set of interacting self-finding units

(76) Inventors: Daniel S. Adrian, Penn Valley, PA (US); Daniel A. Swartz, Gladwynne, PA (US)

Correspondence Address: DUANE MORRIS LLP, PO BOX 5203, PRINCETON, NJ, 08543-5203, US

(21) Appl. No.: 11/255,321

(22) Filed: Oct. 21, 2005

(51) Int. Cl. G08B 1/08; G01S 13/08

(52) U.S. Cl. 340/539.32; 342/139

(57) ABSTRACT

A set of mutually intercommunicating units each include a transmitter arrangement and a receiver responsive to a single encoded signal. Each transmitter arrangement produces any one of the encoded signals other than its own. Each unit is associated with an important or valuable item, such as keys, cellphone, wallet/purse and the like, which are liable to being misplaced. To find a misplaced unit, any other unit is procured, and its transmitter code associated with the missing unit is energized. The missing unit responds to the transmitted code by annunciating, allowing it to be located.

### FIELD OF THE INVENTION

This invention relates to methods for location of devices, such as portable devices, which are liable to be misplaced.

### BACKGROUND OF THE INVENTION

Cellular telephones have come into widespread use. Cellular telephones must be small in order to be maximally useful, and this small size tends to result in their misplacement or “loss.” It was early realized that it was possible to locate a lost operative cellular telephone by using another telephone to ring the lost cellular telephone, whereupon the lost cellular telephone would ring or audibly annunciate, and the annunciation could be used to lead to the lost cellular telephone, whereby it could be found.

Some telephones coupled to the Plain Old Telephone System (POST) are fitted with a base station and with a portable audio handpiece which communicates by radio with the base station. Just like the cellular telephone, the portable handpieces are also liable to be “lost.” Manufacturers of such base-station/radio-handpiece sometimes fit the combination with a “finding” function which includes a pushbutton switch or the like at the base station, which when pressed causes the handpiece to audibly annunciate, with the same effect of allowing the handpiece to be found.

Improved or alternative location systems and methods are desired.

### SUMMARY OF THE INVENTION

A method according to an aspect of the invention is for, given one of a predetermined plurality of units, locating a desired one of the remainder of the units. Each of the units comprises a number, equal to one less than the predetermined plurality, of transmitters of differently coded signals. Each of the differently coded signals which is transmitted by one of the units is associated with one of the remainder of the units. Each of the units also comprises a receiver. Each of the receivers is responsive to the coded signals transmitted by another one of the units for generating a location or annunciator signal. The method comprises the steps of procuring at least one of the units, and, on that one of the units, enabling transmission of that one of the coded signals which is associated with the desired one of the remainder of the units. If the desired one of the remainder of the units is within range of the coded signals which are transmitted, the annunciator will sound on that unit. It is only necessary to follow the location signal to find the desired one of the units.

In a particular mode of the method, the transmission of coded signals comprises the step of transmitting an individual carrier frequency for each of the units.

In another particular mode of the method, the transmission of the coded signals comprises the step of transmitting a carrier signal modulated with one of a plurality of digital signals. Each of the plurality of digital codes is associated with one, and only one, of the remaining units.

A method for finding a desired one of a predetermined plurality of units comprises the steps of associating with each of the plurality of units a transmitter of a number, which number is equal to one less than the predetermined number, of different coded signals, and associating with each of the plurality of units a receiver/annunciator, the receiver/annunciator of each of the plurality of units being responsive to one, and only one, of the differently coded signals, to produce an annunciation signal. The method further includes the step of energizing the receivers of each of the plurality of units. When it is desired to locate a desired one of the units, obtaining an other one of the units, and transmitting from the other one of the units that one of the different coded signals to which the receiver of the desired one of the units is responsive, whereby the receiver of the desired one of the units responds to produce an annunciation signal. The annunciation signal can of course be followed to locate or discover the desired one of the units.

In a particular mode of the method, the step of energizing the receivers takes place before the step of transmitting from the other one of the units.

An individual unit of a set of a predetermined plurality of potentially intercommunicating units, where each of the units comprises electromagnetic signal transmitting means for, when energized, transmitting a selected one of a plurality, equal to one less than the predetermined plurality, of differently coded signals, and electromagnetic receiving/annunciating means for receiving and responding with annunciation to one, and only one, of the differently coded signals. The individual unit of the set also includes selection means coupled to the transmitting means, for selectively causing the transmitting means to transmit one of the differently coded signals to which one of the receiving means is responsive.

### BRIEF DESCRIPTION OF THE DRAWING

FIG. 1 is a simplified diagram illustrating a representative set of three units according to an aspect of the invention;

FIG. 2 is a simplified block diagram of a first alternative of a representative unit of a set of units such as that of FIG. 1, where the unit includes a receiver and a pair of transmitters;

FIG. 3 is a simplified block diagram of a second alternative of a representative unit of a set of units such as that of FIG. 1, including a receiver arrangement and a transmitter arrangement, showing the use of digital codes;

FIG. 4 is a simplified block diagram illustrating another possible embodiment of the transmitter arrangement of FIG. 3; and

FIG. 5 is a simplified block diagram of a third alternative of a representative unit of a set of units such as that of FIG. 1, showing the use of frequency codes.

### DESCRIPTION OF THE INVENTION

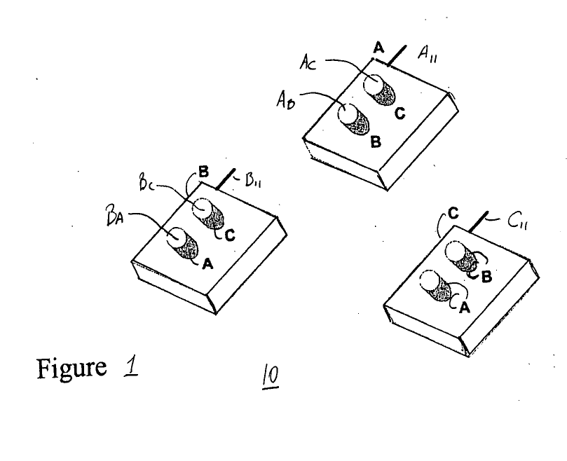

FIG. 1 is a simplified diagram illustrating a set 10 illustrated as including a predetermined number, namely three, portable units designated A, B, and C, but which could include some predetermined number greater than three. In FIG. 1, each of the three units A. B, and C bears a number of locator user interfaces in the form of pushbuttons. The number of locator user interfaces or buttons is one less than the number of units in the set. Thus, each of the units bears two locator user interfaces. In FIG. 1, the unit A bears user locator interfaces A_{B} and A_{C}, unit B bears user interfaces B_{A} and B_{C}, and unit C bears user interfaces C_{A} and C_{B}. Thus, there is a locator user interface associated with each of the portable units of set 10 which is associated with each of the other units of the set. The locator user interfaces A_{B}, A_{C}, B_{A}, B_{C}, C_{A}, and C_{B} may be, for example, pushbutton switches, or in the case where the set includes a large number, a rotary selector switch in conjunction with a single pushbutton switch may be more appropriate.

Each of the units A, B, and C of FIG. 1 also includes one or more transmitter units which are actuated by the locator user interfaces, for transmitting signals, possibly by way of antennas A₁₁, B₁₁, and C₁₁, respectively. Each of the units A, B, and C, upon actuation of a particular one of the locator user interfaces of one of the units, transmits a signal, such as an electromagnetic signal, which is coded so as to be acted upon by only by that one of the other units which corresponds to the particular one of the locator user interfaces. Each unit also includes one or more receivers, which are suited to receiving and acting upon the particular coded signal with which it is associated. Thus, when a particular unit is at hand, as for example unit A of FIG. 1, and one of its locator user interfaces is actuated, such as locator user interface A_{B}, unit A transmits a signal which is coded for action by unit B. The receiver of unit B receives the coded signal, and actuates its audible annunciator to thereby announce its location. On the other hand, if remote unit C is at hand, and unit B is to be found or located, the location user interface C_{B} would be actuated, to thereby cause a transmitter associated with unit C to transmit a signal coded for action by unit B. It should be noted that the coded signal transmitted by unit C in this second situation may be identical to the coded signal transmitted by unit A when unit B is to be found. That is, the coded signal transmitted from unit A, when received by the receiver of unit B, results in actuation of the annunciator, and the same coded signal when transmitted by unit C will also cause actuation of the annunciator of unit B. Thus, regardless of the number of units in a set of units, the maximum required number of codes is no greater than the number of units in the set.

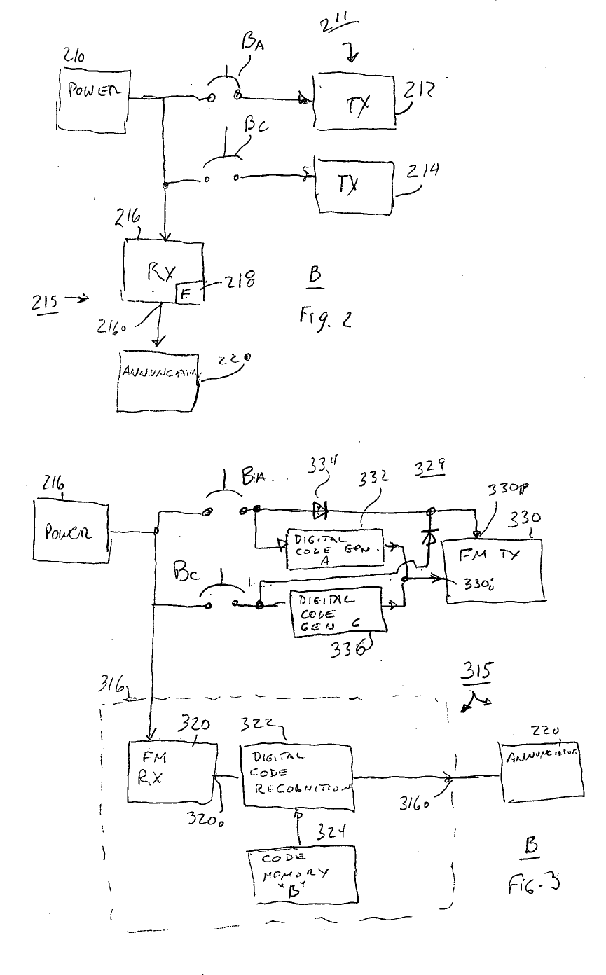

FIG. 2 is a simplified block diagram of a unit of the set 10 of FIG. 1. For definiteness, the unit of FIG. 2 is designated B. As illustrated, unit B of FIG. 2 includes a source of power 210, which may be a battery. Unit B of FIG. 2 also includes a first transmitter (TX) 212 coupled to battery 210 by way of locator user interface B_{A}, illustrated as a pushbutton switch. Unit B of FIG. 2 also includes a second transmitter (TX) 214 coupled to battery 210 by way of locator user interface B_{C}, also illustrated as a pushbutton switch. Transmitters 212 and 214 should be associated with an antenna arrangement (not illustrated in FIG. 2), which can be either individual or common. When locator user interface B_{A} is actuated to provide power to transmitter 212, transmitter 212 transmits at least a carrier signal at a predetermined first radio frequency. The predetermined first radio frequency constitutes or comprises the coding in this situation, for the duration of the pushing of button B_{A}. When locator user interface B_{C} is actuated to provide power to transmitter 214, transmitter 214 transmits at least a carrier signal at a predetermined second radio frequency. The predetermined second radio frequency constitutes or comprises a second portion of the coding.

Unit B of FIG. 2 also includes a receiver 216 which is always connected to power source 210 so as to be continuously energized. Receiver 216 should also be associated with an antenna arrangement (not illustrated), either individual or common with those of the transmitters 212, 214. Receiver 216 includes a carrier-frequency filter (F) 218 which is responsive to a carrier signal at a predetermined third frequency, which third frequency constitutes or comprises the last portion of the coding. Receiver 216 of FIG. 2 has an output port 216o connected to an audio annunciator designated 220. The combination of receiver 216 and annunciator 220 is designated 215. In the simplest arrangement, receiver 216 of unit B responds particularly to carrier at the third frequency, and not to carrier at the first or second frequencies; that is to say, that the carrier-frequency filter 218 at the third frequency rejects carrier signals at the first and second frequencies. Thus, rejected carriers at the first and third frequencies cannot actuate the annunciator 218, but carriers at the second frequency are not rejected by filter 218, and go through the receiver to output port 216o to actuate the annunciator 220. The actuation of the annunciator 220 by the receiver 216 can be implemented by a simple radio-frequency detector associated with the receiver or by more complex arrangements, as known to those skilled in the art.

One may view the unmodulated carrier signal transmitted and responded to in the arrangement of FIG. 2 as a form of direct-voltage or direct-current (DC) amplitude modulation (AM). Those skilled in the art know that receivers such as receiver 216 of FIG. 2, which respond to simple unmodulated carriers, are not robust, and are subject to unwanted responses. That is, a receiver which is responsive to a particular simple carrier frequency may not be reliable, in that the environment is full of signals, some of which may be close enough to one or more of the selected frequency(ies) to create an annunciator response.

FIG. 3 illustrates another possible arrangement for the units of set 10 of FIG. 1. More particularly, FIG. 3 is an alternative simplified block diagram of each unit of set 10 of FIG. 1. As with FIG. 2, FIG. 3 is for definiteness labelled as being unit B. Instead of being responsive to simple radio frequency, the unit B of FIG. 3 includes a receiver 316 which receives a band of frequencies associated with a modulated carrier. The modulation may be amplitude modulation (AM), frequency modulation (FM), phase modulation (PM), or any of a number of more complex modulations, or combinations thereof. In FIG. 3, the assumption is made that receiver 316 receives a frequency-modulated carrier modulated with a digital code. Frequency modulation is more resistant than AM to interference from the environment, and the use of a digital code further improves the robustness of the arrangement.

In FIG. 3, receiver 316 includes an FM receiver (FM RX) 320 which receives (by way of an antenna arrangement, not illustrated) digital-code FM-modulated signal, processes the FM modulated signal, and demodulates the modulation to produce demodulated signal. The modulation in the form of a digital code is generated at output port 320o of FM receiver 320. The digital code is applied to a digital code recognition block 322, which coacts with a memory 324 to be responsive to a particular digital code associated with unit B. Code recognition block 322 either recognizes the received code and produces a “recognized” signal at its output port 322o or it does not recognize the code, and produces no recognition signal. If a “recognized” signal is generated at port 322o, it is applied to annunciator block 220. The combination of receiver 316 with annunciator 220 is designated 315.

Unit B of FIG. 3 also includes a transmitter arrangement designated 330, which includes a modulation input port 330i. Transmitter arrangement 330 should be associated with an antenna arrangement, either individual or common with that of the receiver. Power for transmitter 330 is applied at a power port 330p. A first digital code generator 332 coacts with a memory (not illustrated) to generate a digital code A unique or assigned to a corresponding unit A of the set of units. When locator user interface BA is pressed, power is applied to A digital code generator 332 to produce the A digital code, and power is also applied to FM transmitter 330. The A digital code produced by digital code generator 332 is applied to modulation input port 330i of transmitter 330. As a result, as long as pushbutton switch BA is actuated, FM transmitter 330 transmits FM signals modulated by the A code from code generator 332.

A second digital code generator 336 coacts with a memory (not illustrated) to generate a digital code C unique or assigned to a corresponding unit C of the set of units. When locator user interface B_{C} is pressed, power is applied to C digital code generator 336 to produce the C digital code, and power is also applied to FM transmitter 330. The C digital code produced by digital code generator 336 is applied to modulation input port 330i of transmitter 330. As a result, as long as pushbutton switch B_{C} is actuated, FM transmitter 330 transmits FM signals modulated by the C code from code generator 336.

In operation of a system using A, B, and C units similar to unit B of FIG. 3, except for the coding of the code generators, any one of the three units can be located so long as any other one of the units is available. The overall operation is similar to that described in conjunction with FIG. 1. The details of the functioning of each unit differs among the units, although their operation is similar except for the coding and responses thereto. More particularly, if a set of A, B, and C units exists, and if an A unit is available, its transmitter digital code generators of the A unit will be preloaded with B and C codes, and activation of either of its A_{B} or A_{C} location user interfaces (pushbutton switches in the embodiment) results in transmission of FM signal in some frequency band, modulated with the appropriate one of the B or C digital codes. The A unit will also include an A receiver, responsive to FM signals in the frequency band which are modulated by an A code. The transmitter digital code generators of the B unit will be preloaded with A and C codes, and activation of either of its B_{A} or B_{C} location user interfaces (pushbutton switches) results in transmission of FM signal in the frequency band, modulated with the appropriate one of the A or C digital codes. The B unit will also include a B receiver, responsive to FM signals in the frequency band which are modulated by a B code. The transmitter digital code generators of the C unit will be preloaded with A and B codes, and activation of either of its C_{A} or C_{B} location user interfaces (pushbutton switches) results in transmission of FM signal in the frequency band, modulated with the appropriate one of the A or B digital codes. The C unit will also include a C receiver, responsive to FM signals in the frequency band which are modulated by a C code. So long as the units are within range of each other, any one unit is available, and the user is within audible range, any desired other one of the units can be located by simply actuating the location user interface associated with the desired unit so that its annunciator is actuated, and following the annunciator signal to locate the desired unit.

Those skilled in the art know that the programmable code memory for the transmitter of the arrangement of FIG. 3 may be a single unit programmable for producing the desired transmitter codes. A unit including a microprocessor can perform most of the processing functions to generate the requisite codes and to recognize the received code.

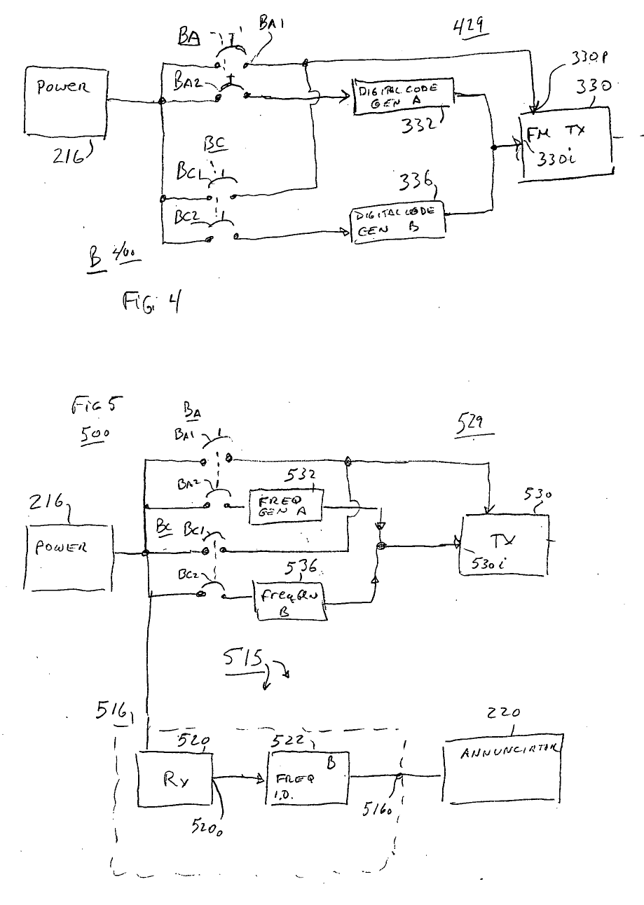

FIG. 4 is a simplified block diagram of another possible arrangement 400 of the transmitters of a B coded unit of set 10 of FIG. 1. In FIG. 4, elements corresponding to those of other FIGURES are designated by the same reference alphanumerics. In FIG. 4, each locator user interface or pushbutton switch is a multiple-switch element. Thus, in FIG. 4, switch B_{A} includes switch portions B_{A1} and B_{A2}, ganged for simultaneous actuation, and switch B_{C} includes switch portions B_{C1} and B_{C2}, ganged for simultaneous actuation. Switch portions BA1 and BC1 are connected together and to power input port 330p of FM transmitter 330, for applying power to the transmitter when either of switches B_{A} or B_{C} is actuated. Switch portions BA2 and BC2 are connected to power source 216 and to A digital code generator 332 and B digital code generator 336, respectively, for applying power to A digital code generator 332 when switch B_{A} is activated and to B digital code generator 336 when switch B_{C} is actuated. Actuation of switches BA and BC of the transmitter arrangement 400 of FIG. 4 has the same net effect as actuation of those switches in the arrangement of FIG. 4.

Another possible modulation scheme uses a transmitter (of any type) modulated by one of a plurality of modulation frequencies, where the selected modulation frequencies are selected to correspond to the various members of the set of units. In FIG. 5, representative B unit 500 includes a power source 216 connected to a receiver 516 (of the same type as the transmitter) for continuous actuation thereof, and for receiving modulated signals addressed to the B unit. B unit receiver 520 produces at its output port 520o a replica of the modulation frequency with which the received signal is modulated. This may or may not correspond with the modulation frequency to which the B unit 500 is responsive. The modulation signal is coupled to a B frequency identification block 522, which does not respond to modulation frequencies other than the selected B modulation frequency, and responds to the B modulation frequency to produce a response signal at receiver output port 516o. The B frequency identification unit 522 may be a discrete filter, or a virtual filter defined by a filter response of a processor. The response signal is applied to annunciator 220 to produce the annunciation signal for locating the B unit. The combination of receiver 516 with annunciator 220 is designated 515.

B unit 500 of FIG. 5 also includes a transmitter arrangement including a transmitter 530 including a modulation signal input port 530i. The arrangement of FIG. 5 also includes ganged B_{A} and B_{C} pushbutton actuators. B_{A} pushbutton includes a first portion B_{A1} and BC pushbutton includes a first portion B_{C1}, either of which, when actuated, couples power to transmitter 530. The B_{A} pushbutton includes a second switch portion B_{A2} ganged with portion B_{A1} which, when actuated, couples power to an A oscillator or frequency generator 532. A oscillator 532, when actuated, generates one of a plurality of tones or frequencies which is assigned to the A unit receiver of the set of units. The B_{C} pushbutton includes a second switch portion B_{C2} ganged with portion B_{C1} which, when actuated, couples power to a C oscillator or frequency generator 536. C oscillator 536, when actuated, generates one of a plurality of tones or frequencies which is assigned to the C unit receiver of the set of units.

In operation of a system using A, B, and C units similar to unit B of FIG. 5, except for the frequencies of the code generators, any one of the three units can be located so long as any other one of the units is available. The overall operation is similar to that described in conjunction with FIG. 1. The details of the functioning of each unit differs among the units, although their operation is similar except for substitution of a frequency for the direct modulation of FIG. 2 or the digital coding of and the responses thereto. As described above, if a set of A, B, and C units exists, and if an A unit is available, its transmitter frequency code generators will be preloaded with B and C codes, and activation of either of its A_{B} or A_{C} location user interfaces (pushbutton switches in the embodiment) results in transmission of signal in some frequency band, modulated with the appropriate one of the B or C frequency codes. The A unit will also include an A receiver, responsive to signals in the frequency band which are modulated by an A code. The transmitter frequency code generators of the B unit will be preloaded with A and C codes, and activation of either of its B_{A} or B_{C} location user interfaces (pushbutton switches) results in transmission of signal in the frequency band, modulated with the appropriate one of the A or C frequency codes. The B unit will also include a B receiver, responsive to signals in the frequency band which are modulated by a B code. The transmitter digital code generators of the C unit will be preloaded with A and B codes, and activation of either of its C_{A} or C_{B} location user interfaces (pushbutton switches) results in transmission of signal in the frequency band, modulated with the appropriate one of the A or B frequency codes. The C unit will also include a C receiver, responsive to signals in the frequency band which are modulated by a C code. So long as the units are within range of each other, any one unit is available, and the user is within audible range, any desired other one of the units can be located by simply actuating the location user interface associated with the desired unit so that its annunciator is actuated, and following the annunciator signal to locate the desired unit.

While not specifically mentioned above, it will be clear that the units of the set may, and preferably must, perform other functions than self-finding. For example, the various different units of a set may be clipped or otherwise affixed to a set of keys, to a wallet or ladies' purse, to a laptop computer or Blackberry, to a cellular telephone, andor to a POST telephone base terminal (and also to its radio handset). They may be associated not only with the abovementioned items but also with an automobile, motorcycle or other vehicle, in which case the annunciation at the vehicle may be by sounding the horn. Tools and electrical equipment, and generally any item of value or portable item which is capable of being misplaced can usefully be attached to a unit of a set according to the invention. In the case of a cellphone, laptop or other electronic equipment, a unit according to the invention may be incorporated into the body thereof.

A method according to an aspect of the invention is for, given one of a predetermined plurality (3) of units of a set (10) of units, locating a desired one of the remainder (2) of the units. Each of the units comprising a number (2), equal to one less than the predetermined plurality (3), of transmitters (211; 329; 429; 529) of differently coded (direct, digitally coded, frequency coded) signals. Each of the differently coded signals (B, for example) which is transmitted by one of the units (A, for example) is associated with one (B) of the remainder of the units (B, C). Each of the units of the set (10) also comprises a receiver (216; 316; 516). The receiver (216; 316; 516) of each unit (A, B, C) is responsive to the coded signals transmitted by another one of the units for generating a location or annunciator signal. The method comprises the steps of procuring at least one of the units (B, for example), and, on that one of the units, enabling transmission of that one of the coded signals (A or C) which is associated with the desired one of the remainder of the units. If the desired one of the remainder of the units is within range of the coded signals which are transmitted, the annunciator (220) will sound on that unit. It is only necessary to follow the location signal to find the desired one of the units.

In a particular mode of the method (FIG. 2), the transmission of coded signals comprises the step of transmitting an individual carrier frequency for each of the units.

In another particular mode (FIG. 3) of the method, the transmission of the coded signals comprises the step of transmitting a carrier signal modulated with one of a plurality of digital signals. Each of the plurality of digital codes is associated with one, and only one, of the remaining units.

In yet another particular mode (FIG. 5) of the method, the transmission of coded signal includes the step of transmitting a signal modulated by one of a plurality of frequencies, which may be audio frequencies, where each of the plurality of audio frequencies is associated with one, and only one, of the remaining units.

A method for finding a desired one of a predetermined plurality (3 in the example) of units (A, B, C) comprises the steps of associating with each of the plurality (3) of units (A, B, C) a transmitter (211, 329, 429, 529) of, or for transmitting a number of different coded signals, which number is equal to one less than the predetermined number (that is, one less than three, or two). The method also comprises associating with each of the plurality of units a receiver/annunciator (215; 315; 515), the receiver/annunciator (215; 315; 515) of each of the plurality of units (A, B, C) being responsive to one, and only one, of the differently coded signals, to produce an annunciation signal. The method further includes the step of energizing the receivers (215, 315, and 515) of each of the plurality of units (A, B, C). When it is desired to locate a desired one of the units (say unit B), obtaining an other one of the units (such as unit A or C), and transmitting from the other one of the units (A or C) that one of the different coded signals (C) to which the receiver/annunciator (215; 315; 515) of the desired one (unit C) of the units is responsive, whereby the receiver/annunciator (215; 315; 515) of the desired one (C) of the units responds to produce an annunciation signal. The annunciation signal can of course be followed by the user to locate or discover the desired one of the units.

In a particular mode of the method, the step of energizing the receivers takes place before the step of transmitting from the other one of the units.

An individual unit, according to an aspect of the invention, of a set of a predetermined plurality (three in the example) of potentially intercommunicating units (A, B, C), where each of the units (A, B, C) comprises electromagnetic signal transmitting means (211, 329, 439, 529) for, when energized, transmitting a selected one of a plurality, equal to one less than the predetermined plurality (three minus one is two), of differently coded signals, and electromagnetic receiving/annunciating means (215, 315, 515) for receiving and responding with annunciation to one, and only one, of the differently coded signals. The individual unit of the set also includes selection means (BA; BA1, BC1) coupled to the transmitting means (211, 329, 439, 529), for selectively causing the transmitting means to transmit one of the differently coded signals to which one of the receiving means is responsive.

What is claimed is:

1. A method for, given one of a predetermined plurality of units, locating a desired one of the remainder of said units, each of said units comprising a number, equal to one less than said predetermined plurality, of transmitters of differently coded signals, each of which differently coded signals is associated with one of the remainder of said units, and each of said units also comprising a receiver, said receiver being responsive to the coded signals transmitted by another one of said units for generating a location signal, said method comprising the steps of:
procuring at least one of said units;
on said one of said units, enabling that one of said coded signals which is associated with the desired one of said remainder of said units; and
following said location signal to find said desired one of said units.

2. A method according to claim 1, wherein said transmitter codes comprise an individual carrier frequency for each of said units.

3. A method according to claim 1, wherein said transmitter codes comprise digital codes modulated onto a carrier.

4. A method according to claim 1, wherein said transmitter codes comprise selected frequencies modulated onto a carrier.

5. A method for finding a desired one of a predetermined plurality of units, said method comprising the steps of:
associating with each of said plurality of units a transmitter of a number, equal to one less than said predetermined number, of different coded signals;
associating with each of said plurality of units a receiver/annunciator, the receiver/annunciator of each of said plurality of units being responsive to one, and only one, of said differently coded signals, to produce an annunciation signal;
energizing said receivers of each of said plurality of units;
when it is desired to locate a desired one of said units, obtaining an other one of said units;
transmitting from said other one of said units that one of said different coded signals to which the receiver of said desired one of said units is responsive, whereby the receiver of said desired one of said units responds to produce an annunciation signal.

6. A method according to claim 5, wherein said step of energizing said receivers takes place before said step of transmitting from said other one of said units.

7. An individual unit of a set of a predetermined plurality of intercommunicating units, each of said units comprising:
electromagnetic signal transmitting means for, when energized, transmitting a selected one of a plurality, equal to one less than said predetermined plurality, of differently coded signals;
electromagnetic receiving/annunciating means for receiving and responding with annunciation to one, and only one, of said differently coded signals; and
means coupled to said transmitting means, for selectively causing said transmitting means to transmit one of said differently coded signals to which one of said receiving means is responsive.
